(19) United States
(12) Patent Application Publication
(10) Pub. No.: US 2026/0054164 A1
(43) Pub. Date: Feb. 26, 2026

(54) VARIABLE RATE ANIMATION PLAYBACK AND ASSOCIATED SYSTEMS, METHODS, AND NON-TRANSITORY COMPUTER-READABLE MEDIA

(71) Applicant: Brain Jar Games, Inc., San Francisco, CA (US)

(72) Inventors: William Pierson Cook, V, San Francisco, CA (US); Jonathan William McEvoy, Petaluma, CA (US); Milcho Georgiev Milchev, Hove (GB); Jose Manuel Soruco Holzmann, Berlin (DE)

(73) Assignee: Brain Jar Games, Inc., San Francisco, CA (US)

(21) Appl. No.: 19/299,318

(22) Filed: Aug. 13, 2025

Related U.S. Application Data
(60) Provisional application No. 63/687,089, filed on Aug. 26, 2024.

(51) Int. Cl. A63F 13/497; A63F 13/54; A63F 13/56; A63F 13/60

(52) U.S. Cl. CPC A63F 13/497; A63F 13/54; A63F 13/56; A63F 13/60

(57) ABSTRACT

A variable rate animation playback system that dynamically alters animation playback rates of video game animations. Animations may be triggered by player input, played without delay, and still synchronize with music being played in the video game. Video game development software and components may allow video game developers to create events associated with the music and configure the events. The variable rate animation playback system may synchronize the video game animations with the events by dynamically setting animation playback rates at runtime. The video game development software and components may also allow video game developers to configure how the variable rate animation playback system may dynamically set the animation playback rate of video game animations at runtime.

### CROSS-REFERENCE TO RELATED APPLICATION

This application claims priority to and seeks the benefit of U.S. Provisional Patent Application No. 63/687,089, filed on Aug. 26, 2024, and entitled “Variable Rate Animation Playback, Supporting Data, and Supporting Tools,” the entirety of which is incorporated by reference herein.

### TECHNICAL FIELD

The present disclosure relates in general to video games, and in particular to video game animations whose animation playback rates may be dynamically determined at video game runtime to synchronize with music played by the video game.

### BACKGROUND

Music in most video games tends to be reactive to the state of the game or to player input. Some video games are designed around music and constrain the player, shifting focus to be on the music first and on gameplay second. For these music-forward video games, the player carefully matches a defined set of actions in time to the music, or the player is expected to carefully match a beat of the music. In these video games, if the player input does not line up with the music, animations can be delayed until the right time in the music, or possibly not even played at all. As a result, players do not have the opportunity to creatively interact with the music while playing the video game.

### SUMMARY

A variable rate animation playback system that dynamically synchronizes video game animations with video game music is described herein. The variable rate animation playback system allows animations to be responsive to player input while still aligning with musical elements, such as beats or tempo, thereby enhancing the immersive experience. The variable rate animation playback system dynamically adjusts animation playback rates during gameplay, ensuring that animations feel choreographed to the music without requiring players to time their inputs precisely.

The variable rate animation playback system addresses several limitations of existing technologies, which typically lack the ability to adjust animation rates dynamically or use music-based events for dynamic synchronization. By offering configurable parameters and runtime flexibility, the variable rate animation playback system provides robust technical solutions for integrating music and animations in a seamless and responsive way.

The benefits are significant for both players and developers. Players enjoy a more engaging and musically integrated experience, where their actions feel like part of a live performance. Developers gain powerful tools to create and manage synchronized events and animations with ease, leading to richer and more dynamic gameplay. Overall, the technologies described herein represent meaningful advancements in gameplay and in interactive audiovisual design for video games.

The disclosure also describes video game development tools that enable video game developers to associate specific events with musical features and configure how animations respond to these events. Video game developers can define which animations should be synchronized, how to locate relevant musical events, and the method of synchronization. The video game development tools also support broader gameplay enhancements, such as triggering lighting effects, non-player character actions, or level transitions, based on musical cues.

### BRIEF DESCRIPTION OF THE DRAWINGS

FIG. 1A is a block diagram depicting development of a video game according to some embodiments.

FIG. 1B is a diagram depicting how an animation playback rate for a portion of an animation in a video game may be determined in some embodiments.

FIG. 2 is a flow diagram depicting a method for playing an animation in a video game that includes a portion having a variable rate animation playback state according to various embodiments.

FIG. 3 is an illustration of a video game playing an animation that includes a portion having a variable rate animation playback state in some embodiments.

FIG. 4 depicts an example interface for selecting or providing music to be played by a video game according to various embodiments.

FIGS. 5A and 5B depict an example interface for providing a beat rate for music to be played by a video game in some embodiments.

FIG. 6 is a flow diagram depicting a method for receiving music to be played by a video game and a beat rate for the music in some embodiments.

FIG. 7 is a flow diagram depicting a method for annotating music according to various embodiments.

FIGS. 8A and 8B depict example interfaces for editing music in some embodiments.

FIG. 9A depicts an example interface for configuring an animation for variable rate animation playback according to various embodiments.

FIG. 9B depicts the example interface of FIG. 9A including a section for providing parameters for a portion of an animation configured for variable rate animation playback in some embodiments.

FIG. 10 depicts a block diagram of an example computing device according to various embodiments.

Throughout the drawings, like reference numerals will be understood to refer to like parts, components, and structures.

### DETAILED DESCRIPTION

Due to limitations of current technologies, existing video games with a focus on music require player input to be in time with the music in order for the video game to play animations. If the player does not provide input in time with the music, the video game animations can be delayed or possibly not even played at all. Such video games may provide a less enjoyable experience for the player.

Described herein is a variable rate animation playback system that may dynamically adjust the animation playback rate of video game animations so as to synchronize the animations with the video game music. The variable rate animation playback system may allow animations to be triggered, without delay, by player input and still have the animations synchronize with music being played in the video game.

Also described herein are video game development software and components that may allow video game developers to create events associated with the music and configure the events. The variable rate animation playback system may synchronize the video game animations with the events. The video game development software and components may also allow video game developers to configure how the variable rate animation playback system may dynamically modify the animation playback rate of video game animations at runtime.

Associating events with music also enables features and functionality other than variable rate animation playback. As described herein, video game developers may use the events to trigger effects during video game play. For example, the color or intensity of lights may be changed in response to events, the timing of non-player actions may be tied to events, or phase changes within levels of the video game may be caused by the events. As another example, events may allow for special actions by a player character within the video game.

The technologies described herein provide technical solutions to technical problems that existing technologies suffer from. First, existing technologies do not dynamically alter animation playback rates at runtime (during video game play). The variable rate animation playback system may provide a technical solution to this technical problem by dynamically altering the animation playback rate of an animation at runtime so that the animation may start from an input of the player and still be synchronized with the music. Second, existing technologies do not allow for events based on features of music (for example, the tempo of the music, such as the beat of the music) to function as points at which animations may be synchronized. The variable rate animation playback system may provide a technical solution to this technical problem by identifying and selecting, based on parameters configured by video game developers, an event with which an animation is to be synchronized.

Still another deficiency of existing technologies is that they do not allow video game developers to specify animations for variable animation rate playback and to configure how the variable animation rate playback may function. The technologies described herein may provide technical solutions to these technical problems by allowing video game developers to specify animations for variable animation rate playback and to configure how the variable rate animation playback system dynamically alters animation playback rates by specifying which events an animation is to synchronize with, how to find the events, and the method used to synchronize the animation with the event. Other distinctions with existing technologies will be apparent.

The technologies described herein provide numerous advantages. One advantage is that the player is not required to provide input in time to the music for an animation to begin playing. Another advantage is that the animation may appear choreographed to the player because the animation playback rate is dynamically altered at runtime to fit both player input and music using the variable rate animation playback system. The variable rate animation playback system may slow down or speed up the animation playback rate in such a way that the changed animation playback rate may be imperceptible or barely perceptible to the player while the synchronization with the music may be apparent to the player. The player may feel as if he or she is a guest musician collaborating with the band to add a new element to the song, resulting in unique audiovisual compositions each time the player plays the video game. Another advantage is that video game developers may easily create events, associate the events with the music, and modify the events. Yet another advantage is that video game developers may easily configure how the variable rate animation playback system dynamically alters animation playback rates. Other advantages will be apparent.

Although many examples described herein refer to video games, the technologies described herein are not necessarily limited to video games. Rather, the technologies may be utilized in other types of interactive audiovisual content or interactive digital experiences. For example, an interactive digital experience such as an interactive digital art exhibit may utilize the technologies described herein to synchronize the display of art in response to user input with events in music being played with the display. Moreover, the technologies described herein may be utilized in products or systems that provide output other than or in addition to visual output, such as tactile or haptic output. For example, a visual reality device or an augmented reality device may synchronize haptic feedback commenced in response to user input with sound output by the visual reality device or the augmented reality device. Other uses of the technologies described herein will be apparent.

### Overview

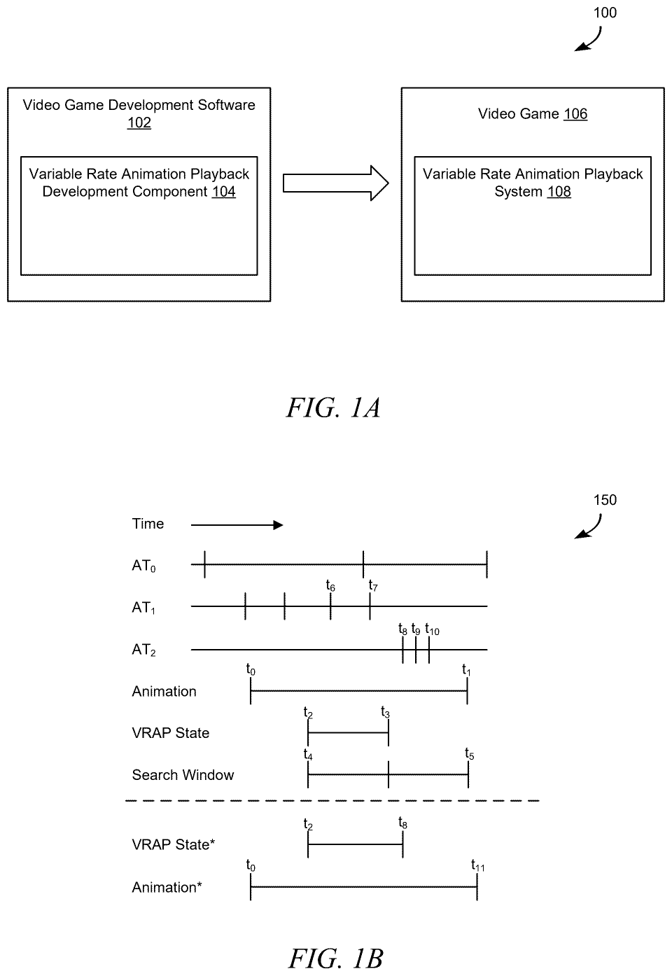

FIG. 1A is a block diagram 100 depicting development of a video game 106 according to some embodiments. The block diagram 100 depicts that video game development software 102 may be used to develop the video game 106. One example of the video game development software 102 is Unreal Engine, which is developed and distributed by Epic Games of Cary, North Carolina. The video game development software 102 may include a variable rate animation playback development component 104 (VRAP development component 104). The VRAP development component 104 may be or include one or more modules, engines, components or the like of the video game development software 102. A video game developer may utilize the video game development software 102, including the VRAP development component 104, to develop the video game 106.

The video game 106 may include a variable rate animation playback system 108 (VRAP system 108). The video game 106 may be or include one or more modules, engines, components or the like of the video game 106. During game play of the video game 106, the VRAP system 108 may modify an animation playback rate of a video game animation to synchronize the animation with events associated with music played by the video game 106. The video game developer may utilize the VRAP development component 104 to create and configure the events and perform other functionality related to variable rate animation playback.

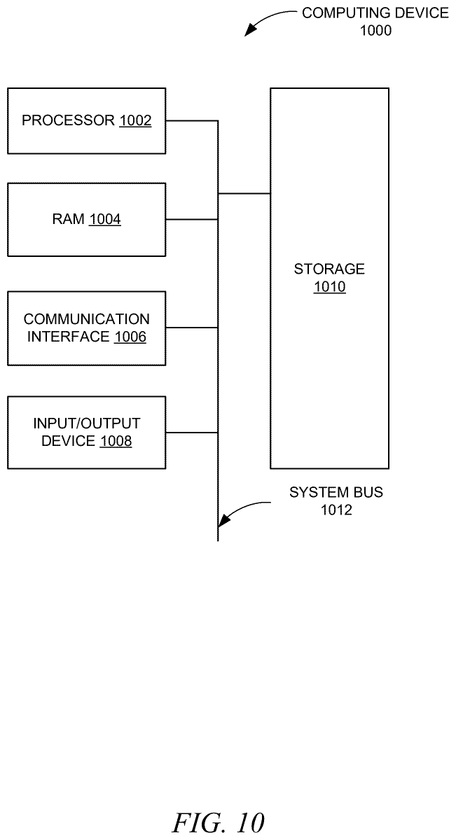

After development of the video game 106 is complete, the video game developer may distribute the video game 106 to players. Computing devices of players (not illustrated in FIG. 1A) may execute the video game 106. A computing device may be or include any device with at least one processor and memory. An example computing device is described herein with reference to FIG. 10. Additionally or alternatively, computing systems to which the computing devices of players are communicably coupled may execute the video game 106, receiving inputs (for example, button presses or key presses, etc.) from the computing devices of the players and providing outputs (for example, audio signals and video signals) to the computing devices of the players.

Although the VRAP system 108 is illustrated as included in the video game 106, some or all of the VRAP system 108 may be included in other software that the video game 106 interfaces with. Similarly, the VRAP development component 104 is illustrated as included in the video game development software 102, but some or all of the VRAP development component 104 may be included in other software that the video game development software 102 interfaces with. Accordingly, the disclosure is not necessarily limited to the configuration depicted in FIG. 1A.

In some embodiments, the VRAP development component 104 (or another component providing some or all of the features and functionality of the VRAP development component 104) may be provided to players of the video game 106 so that players of the video game 106 may utilize the VRAP development component 104 to, among other things, create and configure events and associate the events with music. In such embodiments, the player may be considered as a video game developer.

As illustrated in FIG. 1A, the VRAP system 108 may be provided with the video game 106. In various embodiments, the VRAP system 108 (or another system providing some or all of the features and functionality of the VRAP system 108) may be provided as a standalone system, component, or plugin that may be included in other video games or software. For example, the VRAP system 108 may be provided as a plugin in an online marketplace, such as the Fab marketplace of Epic Games. As another example, the VRAP system 108 may be provided as part of a software development kit (SDK) that may be provided to developers for use in developing other software. The VRAP development component 104 or the VRAP system 108 may be provided as closed source software or as open source software.

### Video Game Runtime

Video game runtime may refer to when a video game is being played by a player. During video game runtime, a video game animation (which may be referred to as an animation) may be several seconds long or less and may apply to a single video game character, such as a player character. An animation may be layered, repeated, started and stopped by video game systems. A video game may have a complex animation state machine created by video game developers that determines at runtime which animation to apply to a video game character. These animation state machines may be influenced by a number of runtime factors, including input from the player, decisions made by artificial intelligence, the status of currently playing animations, and animations of other video game characters (which may be referred to as paired animations, where one game character can trigger an animation that interacts with other game characters), or the in-game environment of the video game character.

One of the most common types of animations that are played on the player character are animations that are started due to player input. For example, movement, attacks, jumps, and dodges are animations that may be started in response to player input. As described herein, existing video games align animations to the music with a typical approach of delaying the start of the animations. This is often a negative experience for players because it appears as if the video games are not reacting to the player inputs. The VRAP system 108 may allow animations in the video game 106 to be both reactive to player input and aligned to the music.

As described herein, animations may be configured during video game development to support variable rate animation playback. In some embodiments, video game developers mark animations, or portions of animations, as having a variable rate animation playback state (VRAP state). At runtime, the VRAP system 108 may dynamically adjust the animation playback rate of animations, or portions of animations, that have a VRAP state, so that the animations, or the portions of animations, may be aligned to the music.

A VRAP state may be for a portion of the animation set by a video game developer. For example, the video game developer may set a start of the VRAP state in the animation and an end of the VRAP state in the animation. As an example, the video game developer may set the start of the VRAP state at the beginning of the animation or at an intermediate point in the animation, and the end of the VRAP state at another intermediate point in the animation or at the end of the animation. The video game developer may set the start and the end of the VRAP state using times, frames, or other references to the animation. When an animation or a portion of the animation is in a VRAP state, the VRAP system 108 may modify the animation playback rate of the animation or the portion of the animation.

An animation may have any number of VRAP states. An animation may be in a VRAP state when the animation is playing, and the playback of the animation is within the bounds of the VRAP state set by the video game developer (for example, within the period of time, the frames, or the other references). When the animation enters the VRAP state, which may be referred to as the animation being in the VRAP state or as the animation playback being in the VRAP state, the VRAP system 108 may adjust the animation playback rate of the portion of the animation that has the VRAP state. For example, the VRAP system 108 may speed up or slow down how fast the animation is playing. The VRAP system 108 may adjust the animation playback rate in order to align a sync point with an event associated with the music that is currently playing in the video game. A sync point may be referred to as a point in the VRAP state of the animation that should be matched to an event associated with the music (for example, an event in a track associated with the music). In some embodiments, only one sync point is set per VRAP state, and if multiple sync points are desired, multiple VRAP states are created per animation. However, in other embodiments, a VRAP state may have multiple sync points.

When an animation is playing in the video game 106 and playback enters a VRAP state, the VRAP system 108 may perform the following steps: First, the VRAP system 108 may search for events associated with the music that may occur near sync points in the animation if the animation playback rate were unadjusted. Second, the VRAP system 108 may select an event from these events for each sync point. The VRAP system 108 may select the event based on parameters set by the video game developer. Third, the VRAP system 108 may determine an animation playback rate such that, when the animation is played at the animation playback rate, the animation may arrive at the sync point when the music reaches the selected event. Fourth, the VRAP system 108 may play the animation at the animation playback rate. The animation may arrive at the sync point when the music reaches the selected event.

FIG. 1B is a diagram 150 depicting how an animation playback rate for a portion of an animation in the video game 106 may be determined in some embodiments. The diagram 150 may represent a situation where input by the video game player is not in time to the music played by the video game 106. The lines labeled AT₀, AT₁, and AT₂ may represent tracks that are associated with the music. Generating tracks and associating events with tracks to generate annotated tracks is discussed in more detail herein. An annotated track may refer to a track that has information added to the track or associated with the track. The tick marks in the AT₀, AT₁, and AT₂ lines (such as those at t₆, t₇, t₈, t₉, and t₁₀) may be for times corresponding to events in the annotated tracks. Annotated tracks may also be referred to herein as tracks.

The animation may begin at time to and may play unaltered by the VRAP system 108 until the animation enters the VRAP state at time t₂. At this point, the VRAP system 108 may create a search window for events based on parameters set by the video game developer. In this example, the search window has been set to be around a sync point at time t₃, and the size has been set such that the search window extends from time t₄ to time t₅. The VRAP system 108 may access the annotated tracks represented by lines AT₀, AT₁, and AT₂ to identify one or more events within the search window. The VRAP system 108 may find events in the annotated tracks at times t₆, t₇, t₈, t₉, and t₁₀. The VRAP system 108 may disregard other events in the annotated tracks because the other events are outside of the search window. In this example, the video game developer has selected a least distortion to the animation parameter for how to select an event, so the VRAP system 108 may select the event that is closest to the sync point t₃, which is the event at time t₈.

Based on the selected event at time t₈, the VRAP system 108 may determine an animation playback rate for the animation for the duration of the VRAP state such that the VRAP state will end at time t₈, as shown in diagram 150 by the line labeled VRAP State*. The time ta is after the end of the time t₃, so the VRAP system 108 may slow the animation playback rate for the portion of the animation in the VRAP state. As a result of this, the end time for the entire animation may also be delayed slightly, from time t₁ to time t₁₁ in the line labeled Animation*. The diagram 150 depicts the updated timeline for the VRAP state and the animation as the lines labeled VRAP State* and Animation*, respectively.

If the video game developer had desired the animation to speed up instead of slow down, the video game developer could have set a parameter for the search window to be prior to the sync point at time t₃ in the VRAP state instead of around the sync point at time t₃. In such a case, the events at times t₈, t₉, and t₁₀ would not be within the search window, and the VRAP system 108 would instead select the event at time t₇. Since the event at time t₇ is before time t₃, the VRAP system 108 would speed up the animation playback rate for the portion of the animation in the VRAP state.

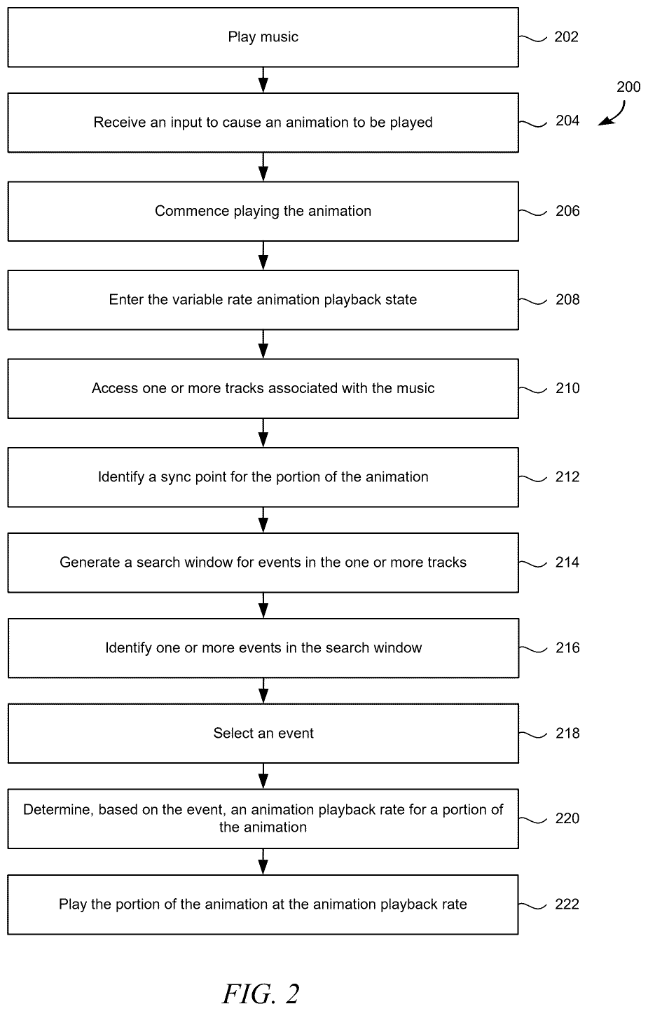

FIG. 2 is a flow diagram depicting a method 200 for playing an animation in the video game 106 that includes a portion having a variable rate animation playback state according to various embodiments. The method 200 is described in the context of a computing device or a computing system executing the video game 106 that is being played by a player, which may be referred to as at video game runtime. The VRAP system 108 or other components of the video game 106 may perform some or all of the steps of the method 200. Although certain steps are described as being performed by the video game 106 and other steps are described as being performed by the VRAP system 108, it is to be understood that the video game 106, the VRAP system 108, or other associated software may perform some or all of the steps of the method 200.

The method 200 may begin at step 202 where the video game 106 may play music. The music may be or include a song. At step 204 the video game 106 may receive an input from the player to cause an animation to be played by the video game 106. For example, the player may press a button or manipulate a control to provide the input. The input may cause the video game 106 to apply an animation, such as an animation to the video game player character. The animation may include a portion that has a VRAP state. At step 206 the video game 106 may commence, without delay, playing the animation. Among other things, commencing playing the animation without delay allows the video game 106 to feel responsive to the player. In some embodiments, commencing playing the animation without delay may refer to commencing playing the animation without an intentional delay, such as an intentional delay caused by the video game 106. “Delay” in the phrase “without delay” is not intended to be understood as referring to delays due to processing, communications, or other conventional procedures of the computing device or computing system executing the video game 106.

At step 208 the VRAP system 108 may, while playing the animation, determine that the animation has entered the VRAP state. At step 210 the video game 106 may access one or more tracks associated with the music. Each track of the one or more tracks may include one or more events, and therefore the one or more events may be associated with the music. At step 212 the VRAP system 108 may identify a sync point in the portion of the animation that has a VRAP state. In some embodiments, the sync point is located at the end of the portion of the animation. However, the sync point may be located at any position in the portion of the animation.

At step 214, the VRAP system 108 may generate, based on the sync point, a search window for events in the one or more tracks. For example, as discussed with respect to FIG. 1B, the VRAP system 108 may generate a search window around a point in time that matches the sync point and with the beginning and the end of the search window equidistant from the point in time. Other possibilities for the search window may be at a point in time that is prior to the time that matches the sync point and at a point in time that is after the time that matches the sync point.

At step 216 the VRAP system 108 may identify one or more events in the search window. At step 218 the VRAP system 108 may select an event from the multiple events associated with the music. For example, the VRAP system 108 may select an event from the one or more events identified as in the search window.

At step 220 the VRAP system 108 may determine, based on the event, an animation playback rate for the portion of the animation. The VRAP system 108 may determine the animation playback rate such that, when the portion of the animation is played at the animation playback rate, the portion of the animation ends when the music reaches the selected event. At step 222 the video game 106 may play the portion of the animation at the animation playback rate. The determined animation playback rate may be sped up, slowed down, or the same as the animation playback rate of the remainder of the animation. In some embodiments, the VRAP system 108 may adjust or cause to be adjusted an interpolation rate used to interpolate between poses of the animation. The portion of the animation may end when the music reaches the event. That is, the sync point in the portion of the animation that has the VRAP state may be reached at the same time that the music reaches the event.

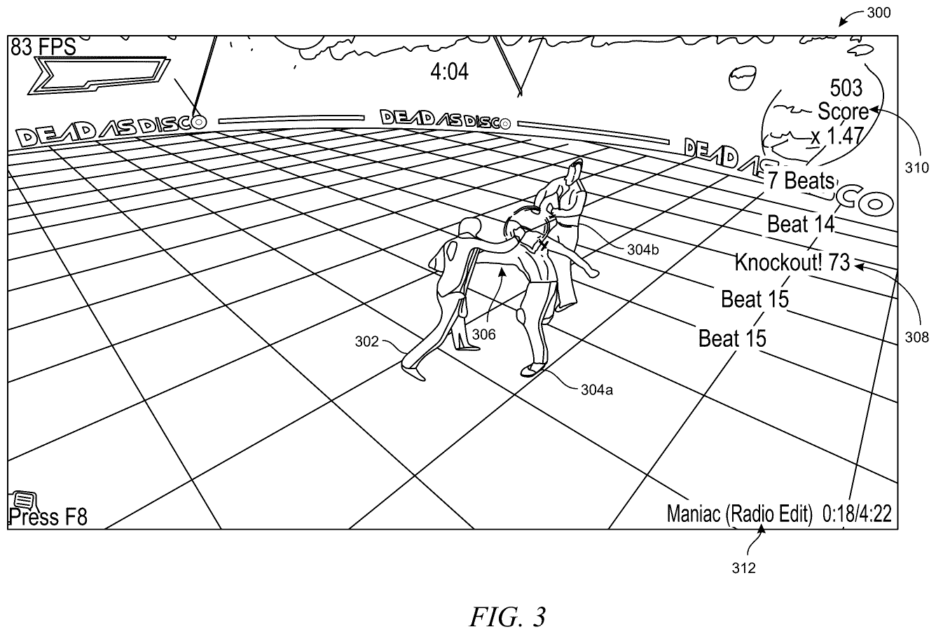

FIG. 3 is an illustration 300 of the video game 106 playing an animation that includes a portion having a variable rate animation playback state in some embodiments. The video game 106, which may be a music-synced action game, may allow a player to control a player character to, among other things, fight non-player characters (NPCs). An NPC may refer to any character in the video game that is not controlled by the player. The video game 106 may play a song 312 while the player controls the player character 302. As depicted, the player character 302 is fighting a first NPC 304a and a second NPC 304b. The video game 106 has applied a punch animation 306 to the player character 302 in response to input from the player. The video game 106 may display a label 308 corresponding to the effect or result of the punch animation 306 and also display a score 310 of the player.

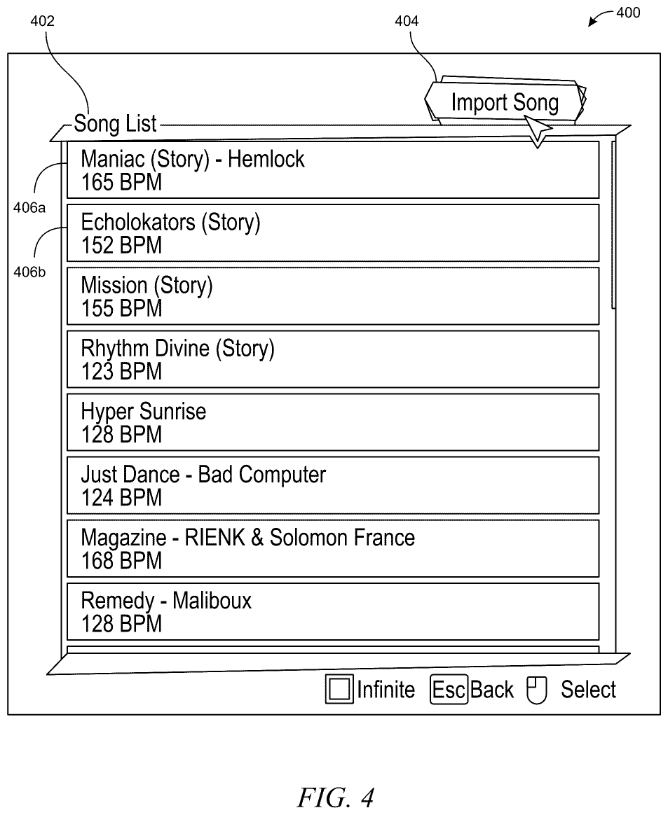

The video game 106 may include multiple songs (such as the song 312) that a player may select to have the video game play while the player is playing the video game. In some embodiments, the video game 106 may allow the player to select or provide music, such as a song, for the video game 106 to play. FIG. 4 depicts an example interface 400 for selecting or providing music to be played by the video game 106 according to various embodiments. The video game 106 may display the interface 400 to allow a player of the video game 106 to select a song provided by the video game 106 or to provide a song to the video game 106. The interface 400 includes a song list 402 that includes multiple songs, such as song 406a and song 406b. The player may select a song in the song list 402. The video game 106 may then receive the song (for example, in memory of the computing device or the computing system executing the video game 106).

Alternatively, the player may select the button 404 labeled “Import Song” to provide a song to the video game 106, such as a song stored on the computing device of the player or at a network location accessible to the player. If the player selects the button 404, the video game 106 may provide or cause to be provided an interface that allows the player to select a song on the computing device or at the network location. After the player has selected a song, the video game 106 may then receive the song (for example, in memory of the computing device or the computing system executing the video game 106).

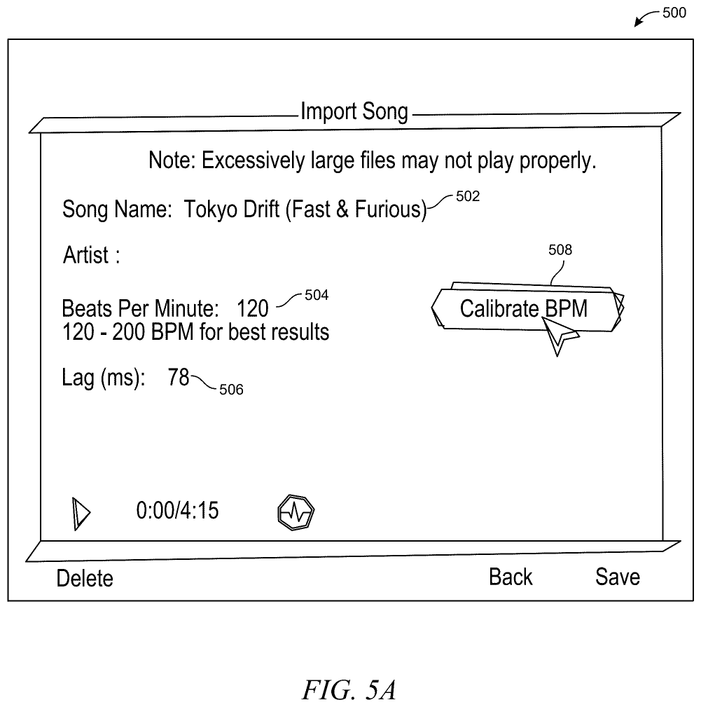

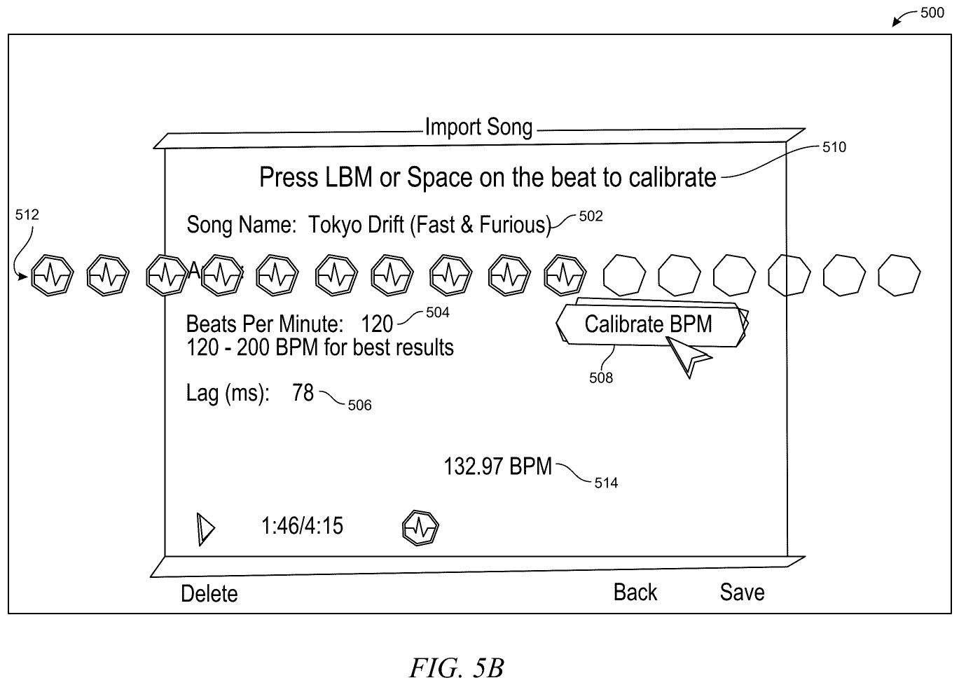

FIG. 5A depicts an example interface 500 for providing a beat rate for music to be played by the video game 106 in some embodiments. The interface 500 displays a song 502 that the player provided. The interface 500 also displays an editable field 504 in which the player may provide a beat rate (expressed in beats per minute) of the song 502. The interface 500 also displays an editable field 506 in which the player may provide a lag (as measured in milliseconds (ms)) for when the first beat of the music begins relative to the start of playback of the music. For example, if the song 502 is 120 beats per minute, the song 502 will have a beat every 0.5 seconds(s). The first beat in the song 502 may not be at 0.0 s or at 0.5 s. Instead, the first beat may be at 0.25 s in the song 502, causing all beats to be shifted by 0.25 s relative to the start of playback (that is, the first beat will be at 0.25 s, the second beat at 0.75 s, then subsequent beats at 1.25 s, 1.75 s, 2.25 s, and so forth). In this case, the lag would be 0.25 s. The lag may also be referred to as an offset. The editable field 506 may display a lag as detected by the video game 106. The player may provide the lag of the song 502 in the editable field 506. If the player knows the beat rate of the song 502 the player may provide the beat rate in the editable field 504. Additionally or alternatively, the player may select the button 508 labeled “Calibrate BPM” to calibrate the beat rate of the song 502.

If the player selects the button 508, the video game 106 may change the interface 500 to allow the player to calibrate the beat rate, as depicted in FIG. 5B. The video game 106 may play the song 502 or a portion of the song 502 and indicate via instructions 510 to the player that the player is to provide input (for example, via a button press or a key press) on the beat of the song 502 or the portion of the song 502 as it is playing. The player may provide the input (for example, by a press of a mouse button or a press of the space key). The interface 500 may display visual elements 512 and fill in the visual elements 512 as the player is providing the input. The interface 500 may also display a beat rate 514 that the video game determines based on the input provided by the player. The player may utilize the determined beat rate or modify the beat rate in the editable field 504. After the beat rate is provided or determined, the video game 106 may utilize the beat rate to associate events with the song 502. In some embodiments, the video game 106 may also take the lag into account in associating events with the song 502.

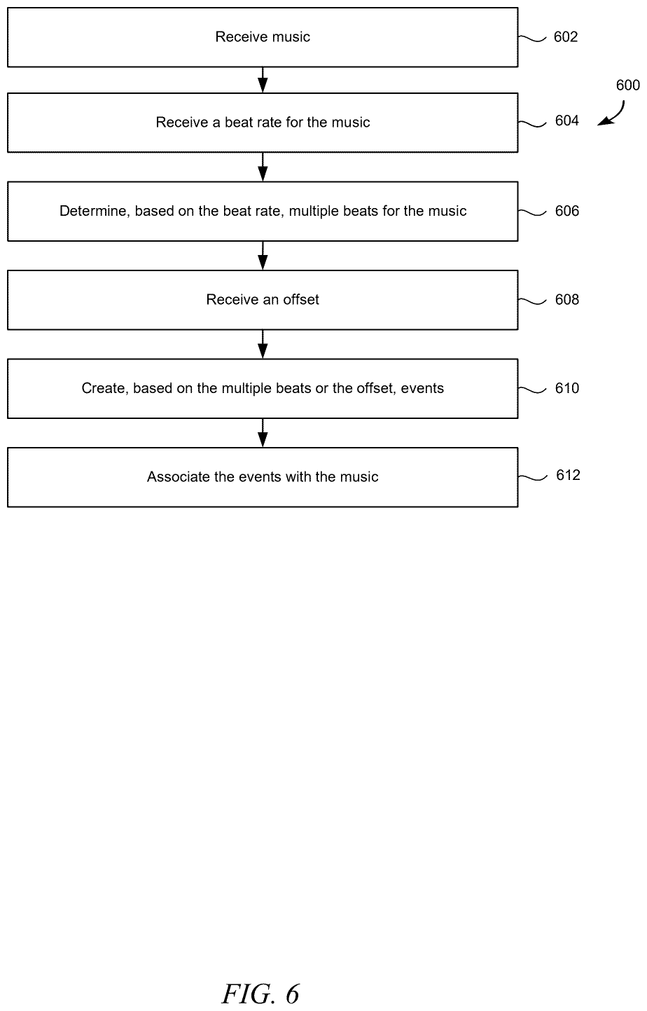

FIG. 6 is a flow diagram depicting a method 600 for receiving music to be played by the video game 106 and a beat rate for the music in some embodiments. The method 600 is described in the context of a computing device executing the video game 106 that is played by a player. The VRAP system 108 or other components of the video game 106 may perform some or all of the steps of the method 600. The method 600 of FIG. 6 may be performed prior to the method 200 of FIG. 2, and accordingly, one or more steps of the method 600 may be performed prior to one or more steps of the method 200.

The method 600 may begin at step 602 where the video game 106 receives the music. For example, the video game 106 may receive a selection of an included song or receive a song from a player as depicted in FIG. 5A. At step 604 the video game 106 may receive a beat rate for the music. For example, the video game 106 may store the beat rates for included songs and receive the beat rate for the included song that is selected by the player. As another example, the video game 106 may receive a beat rate for the music based on input from the player as depicted in FIG. 5A or 5B, or the video game 106 may query a network database to obtain the beat rate. At step 606 the video game 106 may determine, based on the beat rate, multiple beats for the music. At step 608 the video game 106 may receive an offset for the music. For example, the video game 106 may store the offset for included songs and receive the offset for the included song that is selected by the player. As another example, the video game 106 may receive an offset for the music based on input from the player as depicted in FIG. 5A, or the video game 106 may query a network database to obtain the offset. At step 610 the video game 106 may create, based on the multiple beats or the offset, multiple events. For example, the video game 106 may create an event for each beat or for each half beat or quarter beat, or other subdivision of a beat. At step 612 the video game 106 may associate the multiple events with the music. For example, the video game 106 may analyze the music to determine the times of the beats in the music and associate the multiple events with those times.

### Video Game Development

Video game development may refer to the time in which one or more video game developers perform actions to prepare a video game for players. Video game developers typically do video game development. A video game developer may refer to a video game programmer, designer, animator, musician, or any other person who is preparing the video game, or an aspect of the video game, for use by players of the video game. In some embodiments, a player of the video game may do video game development.

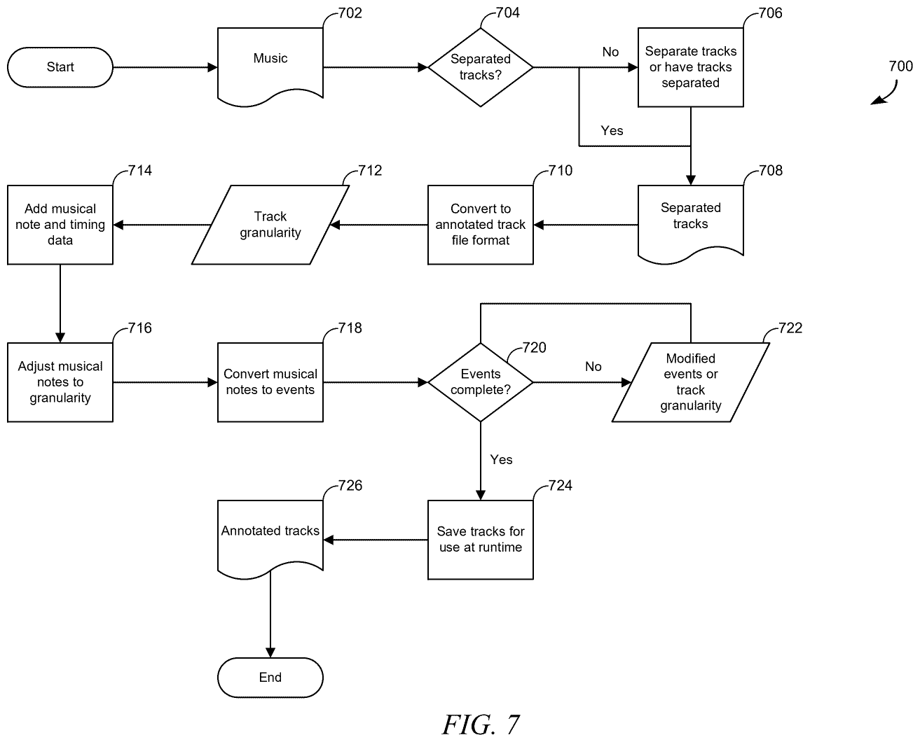

During video game development, a video game developer may annotate music, such as songs, to prepare the music for use with the VRAP system. FIG. 7 is a flow diagram depicting a method 700 for annotating music according to various embodiments. The method 700 is described in the context of a computing device or a computing system executing the video game development software 102 that is being utilized by a video game developer. The method 700 may be performed by the VRAP development component 104 or other components of the video game development software 102. The method 700 of FIG. 7 may be performed prior to the method 200 of FIG. 2, and accordingly, one or more steps of the method 700 may be performed prior to one or more steps of the method 200. Although certain steps are described as being performed by the video game development software 102 and other steps are described as being performed by VRAP development component 104, it is to be understood that the video game development software 102, the VRAP development component 104, or other associated software may perform some or all of the steps of the method 700.

In the method 700, the video game development software may receive music 702. The music 702 may be or include a song. At step 704, the video game development software 102 may determine whether the music is separated into one or more tracks. Typically, music may be separated such that each track is an isolated instrument or vocalist. If the music is not separated into one or more tracks, the method 700 may continue at step 706, where the music may be separated into one or more tracks by the video game development software 102 or by other software. There are existing tools that can separate music into one or more tracks. As an alternative to using such tools, occasionally the source tracks used to create the music may be obtained. For example, if the music has been developed in-house or the owner of the music releases the source tracks, the source tracks may be obtained by the video game development software. The video game development software 102 may receive the separated tracks 708.

At step 710, the VRAP development component 104 may convert the file format of the separated tracks to a different file format that may allow for annotation of the tracks. This format may be referred to as an annotated track file format. The VRAP development component 104 may set a track granularity 712 for each track. The track granularity 712 may refer to a measurement of time defined as a fraction of a note for the music, such as the shortest possible time period to use as the base timing unit for an annotated track. In some embodiments, the track granularity 712 is defined as a subdivision of a full bar or beat. At step 714 the VRAP development component 104 may add musical notes to the imported track. At step 716 the VRAP development component 104 may adjust the timing of the musical notes so that the musical notes are quantized to a musical grid to fit the track granularity 712. An example of this type of quantization is if a track has a drumbeat that is slightly off the note timing, the video game development software may move the drumbeat to the closest note timing.

At step 718, the VRAP development component 104 may convert musical notes to events and store such events in association with the music. Events may be a more generalized way of storing musical note data. Events may encapsulate a wide variety of data, including musical information, numbers, colors, intensity level (for example, audio volume, light brightness, or visual effect velocity), direction, or even references to complex data types (for example, NPC type and spawn location, enemy attack modifiers, or player bonuses). Other data may also be added as events and such events stored in association with the music.

At step 720, if the creation or modification of events is not complete, the VRAP development component 104 may receive modified events or track granularity 722. For example, video game developers may manually modify events or track granularity so that the eventual use of the tracks at runtime can match the video game developer's creative vision.

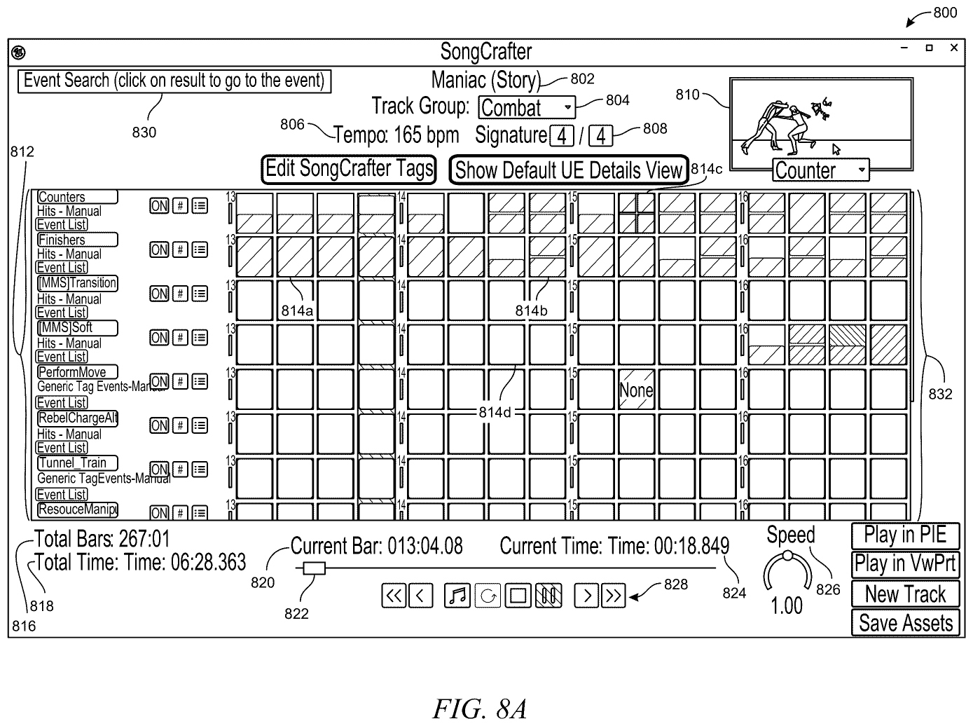

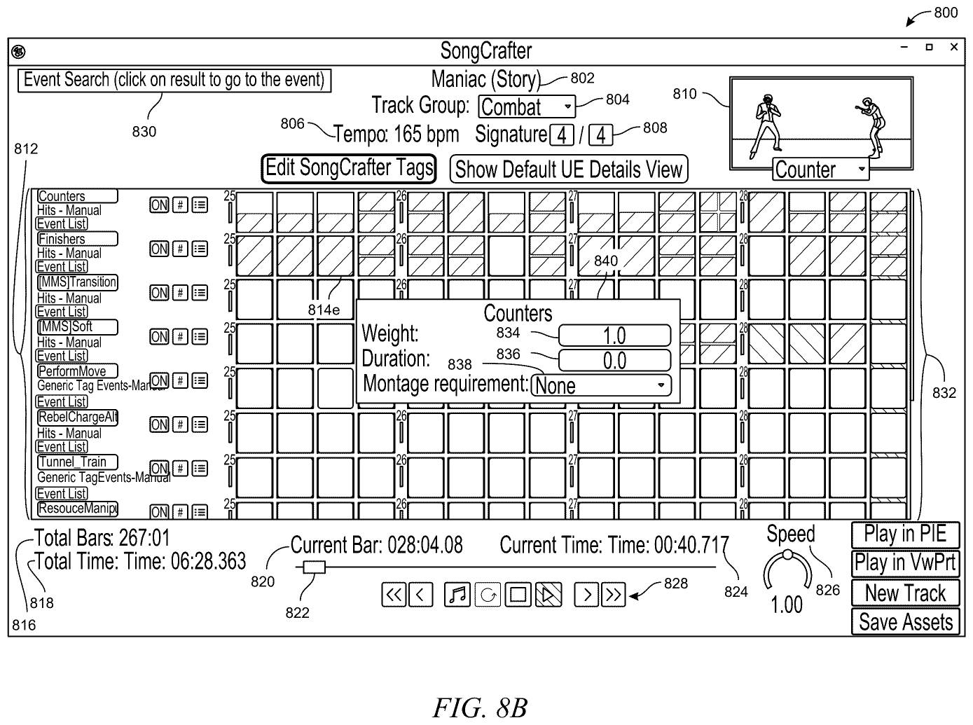

FIGS. 8A and 8B depict an example interface 800 for editing music in some embodiments. The video game development software 102 or the VRAP development component 104 may provide the interface 800. A video game developer may utilize the interface 800 to create and edit annotated tracks that may be used at video game runtime, such as a group of annotated tracks corresponding to music played by the video game at runtime. Tracks may originate from music, as described herein, or may be created by a video game developer using the interface 800.

The interface 800 displays a name 802 of the music with which annotated tracks 812 are associated, a tempo 806 of the music (expressed in beats per minute), and a signature 808 of the music. The video game developer may annotate tracks with a track group type 804, which allows the video game developer to show or to hide tracks in the interface 800 based on their goals. The interface 800 displays the annotated tracks 812 that are not hidden in the interface. The interface 800 also displays events associated with the annotated tracks 812 in a grid 832 that is aligned to the desired track granularity. The grid 832 may include undivided squares, such as undivided square 814a, as well as subdivisions of squares, such as square subdivision 814b, which is a half of an undivided square, or square subdivision 814c, which is a quarter of an undivided square.

An undivided square or a square subdivision in the grid 832 may represent both a potential event and the smallest level of allowed precision for the annotated track. An undivided square or a square subdivision may be empty to indicate there is no event at that time (for example, empty square 814d) or filled if there is an event at that time (for example, undivided square 814a). The interface 800 allows the video game developer to select the squares to place or modify an event and the event's data, which can then be used at runtime, or to remove an event. The video game developer may also select a square in the grid 832 to change it from undivided to subdivided, to change the number of subdivisions, or to change it from subdivided to undivided. For example, the video game developer may select the undivided square 814a to change it to two subdivisions of a square or to four subdivisions of a square or back to the undivided square 814a. The interface 800 may allow for other than two or four subdivisions (for example, three subdivisions, five subdivisions, six subdivisions, and so forth).

The interface 800 also displays other information about the music, such as a total number of bars 816 of the music and a total time 818 of the music. The interface 800 also displays a current bar 820, a current time 824, and a position 822 in the music. While using the interface 800, the video game developer may wish to listen to the music for the annotated tracks. The video game developer may use playback controls 828 to control playback of the music and speed control 826 to control the speed at which the music is played. The interface 800 also displays a panel 810 that may show an animation that is associated with one or more of the annotated tracks 812. The video game developer may search for events in the annotated tracks 812 using a search field 830.

FIG. 8B displays the interface 800 after the video game developer has selected an undivided square or a square subdivision that is filled, such as the square 814e. Selecting the square 814e causes the interface 800 to display a window 840 in which parameters that relate to the event may be set. As displayed, the window 840 displays parameters that relate to counter attacks, such as a weight parameter 834 that relates to an intensity of a counter attack, a duration parameter 836 that relates to a length of a counter attack, and a montage requirement parameter 838 that may relate to selecting which animation may play. Other annotated tracks may have different parameters. For example, an annotated track corresponding to lighting may have parameters that relate to lights, such as colors of lights.

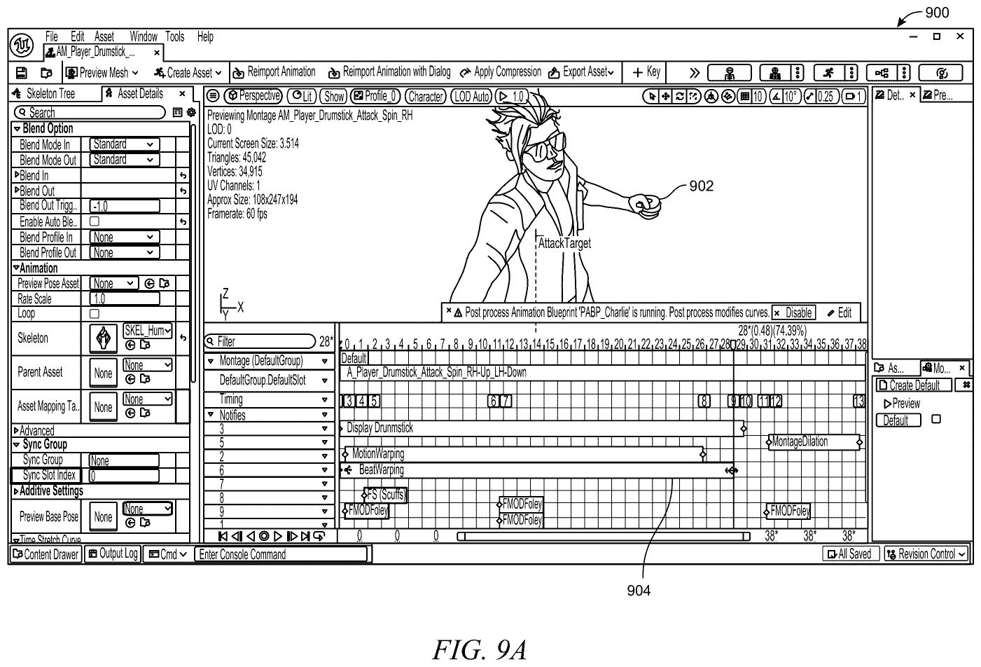

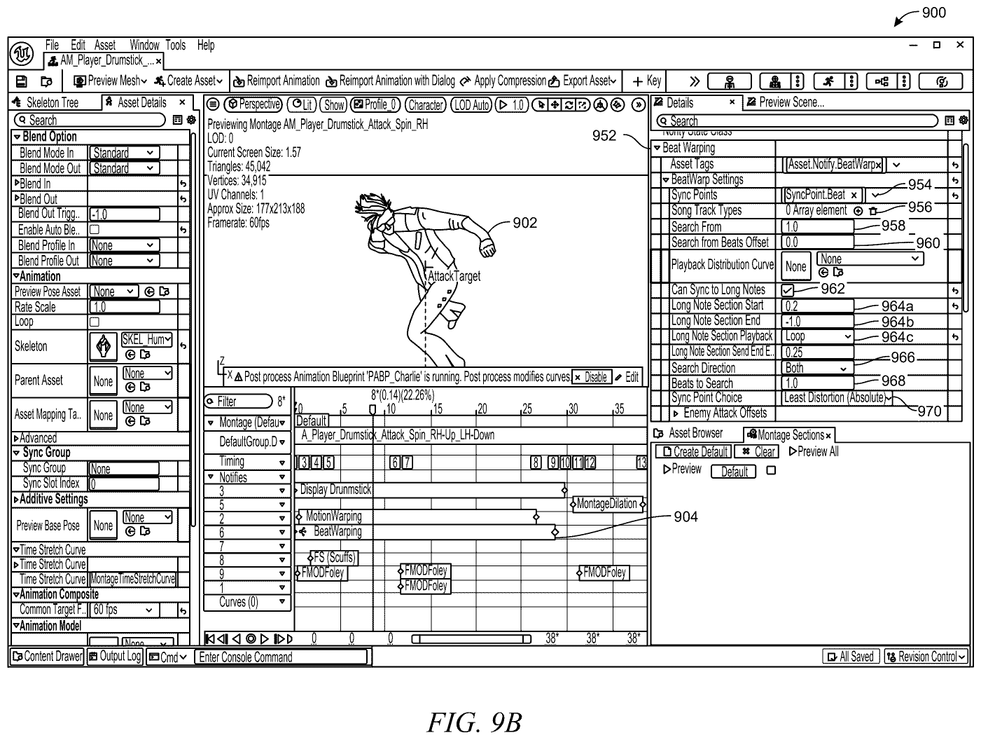

FIG. 9A depicts an example interface 900 for configuring an animation for variable rate animation playback according to various embodiments. The video game development software 102 or the VRAP development component 104 may provide the interface 900. The interface 900 includes a panel that displays an animation 902. The interface 900 also includes a section where the video game developer may define a tag 904 (labeled “BeatWarping”) to configure the animation 902 (or a portion of the animation 902) to have a VRAP state for variable rate animation playback. FIG. 9B displays the interface 900 including a section 952 for providing additional parameters that may be set by the video game developer to control how the VRAP system 108 may determine the animation playback rate for the animation 902 (or a portion of the animation 902).

The additional parameters may include a parameter 956 for determining which annotated tracks to use as sources of events to match to the sync points in the VRAP state and a parameter 954 for determining which events to match to the sync points in the VRAP state. In some embodiments, if the parameter 954 is set to SyncPoint.Beat, then the VRAP system 108 may utilize beats, half beats, quarter beats, or other subdivisions of beats as events. If the parameter 954 is also set to SyncPoint.Midi, then the VRAP system 108 may also utilize events that have been specified through the interface 800 of FIGS. 8A and 8B, such as the event for undivided square 814a.

The additional parameters may include parameters that relate to how the VRAP system is to generate a search window on the annotated tracks to use to find a matching event for the sync point. For example, parameter 966 may relate to where to place the search window. In some embodiments, the VRAP system 108 may place the search window at one of three locations, starting from the point in time on the annotated track that would match the animation's sync point if the animation playback rate were not changed: 1) after the starting point on the annotated track; 2) prior to the starting point on the annotated track; and 3) around the starting point, using it as the center of the range.

The additional parameters may also include a parameter 968 that may relate to the size of the search window. In some embodiments, the size of the search window may be defined as a number set by the video game developer which indicates a number of beats in size. In such embodiments, a search window size of one (1) to two (2) beats may be utilized. Other additional parameters may include a search from parameter 958, a search from beats offset parameter 960, a can sync to long notes parameter 962, and a long note section start parameter 964a, a long note section end parameter 964b, and a long note section playback parameter 964c that relating to synchronizing to long notes. A note that is held in the music may be referred to as a long note. A long note may be held for several beats. If the can sync to long notes parameter 962 is enabled, then the VRAP system 108 may synchronize to long notes. The VRAP system 108 may synchronize to long notes in one of two ways: 1) as if there is an event every quarter beat; or 2) to stretch a defined section of the VRAP state to fit the long note. The long note section start parameter 964a and the long note section end parameter 964b may define the section of the VRAP state that the VRAP system 108 should utilize to synchronize to the long note. The long note section playback parameter 964c may indicate whether the VRAP system 108 is to synchronize as if there is an event every quarter beat or to stretch the defined section of the VRAP state to fit the long note.

The additional parameters may also include a parameter 970 that may relate to the method used to determine the best sync point. In various embodiments, the parameter 970 may allow for the following options: 1) the earliest event in the search window; 2) the latest event in the search window; 3) the least distortion to the animation, as measured by comparing absolute difference in time of the animation playback for different potential events in the search window; 4) the least distortion to the animation, as measured by using an inverse relationship comparing time compression to expansion such that cutting the state time in half is equivalently desirable to doubling the time (possibly with a defined coefficient); and 5) selecting an event based on a logarithmic function.

In some embodiments, if the VRAP system 108 does not find an event for a sync point, the VRAP system does not adjust animation playback rate. To avoid this result or reduce the likelihood of this result occurring, video game developers may include the beat as one of the annotated tracks and set the search window size to be at least one beat. Doing so typically guarantees there will always be at least one event within the search window.

As a result of the VRAP system 108, animations with VRAP states will rarely have the same runtime playback duration because various portions of the animation will have been sped up or slowed down to match specific moments of the song. Additionally, iconic moments in the animation such as hit impacts, iconic poses, footsteps, and others, will happen in time with the song during runtime, even if the player does not time their inputs with the song. This gives the appearance of the animation being carefully crafted with the dramatic moment of the song and the timing of the player input in mind.

Returning to FIG. 7, if the creation or modification of events are complete, the method 700 may continue to step 724, where the VRAP development component 104 may store the one or more tracks, which may be referred to as annotated tracks 726. The VRAP system 108 may utilize the annotated tracks 726 during video game runtime, along with other video game assets such as animations. As described herein, the VRAP system 108 may utilize the annotated tracks to determine an animation playback rate of an animation or portion of an animation.

### Example

A video game developer wishes to use a song with the VRAP system 108 in the video game 106. The song includes a drumbeat at a 120 beats per minute tempo, and a singer with some lyrics. The video game developer takes the file for this song, which may be in a standard audio format (such as .wav, or .mp3) and has the song separated into two tracks: one for the drumbeat and one for the singer. The video game developer imports the song and the two separated tracks into the VRAP development component 104. During the import process, the video game developer sets the track granularity of the drum track to be a quarter of a note. The drummer for this song may not have had perfect timing, so some of the drumbeats may be off by a fraction of a second. The video game development software adjusts the timing of these off-beats to fit the quarter-note granularity of the track. The video game developer saves the annotated tracks for this song, and is done annotating tracks for the song.

In this example, all animations for the game are crafted with a 180 beats per minute tempo. One such animation could be a punch that has three distinct portions: 1) a windup (one beat); 2) a swing (one beat); and 3) follow through (two beats). The entire animation is four beats, or approximately 1.33 seconds long.

The video game developer creates two VRAP states for this animation, one each for the first two portions. The windup VRAP state has preferences that place the search window for the VRAP state prior to the sync point, using the drumbeat track, with a search window size of one beat. The video game developer selects a search window prior to the sync point because the video game developer knows that doing so means the VRAP system 108 will find an event earlier than the sync point to use. The video game developer does this because the video game developer wants the wind up portion of the animation to always be equal to or faster than the speed at which it was originally animated.

Conversely, the video game developer sets the swing VRAP state preferences search window to be around the sync point because the video game developer wants the swing to take longer if that results in less distortion of the animation. The swing VRAP state preferences also use the drumbeat track and have a search window size of one beat. The video game developer knows the drumbeat track has an event every beat, so setting the search window size to one beat for both VRAP states guarantees that the VRAP system 108 will find an event.

Later, a player is playing the video game, and the video game is playing this song. The player presses a button to start a punch. The video game commences, without delay, to play the punch animation described above. The player did not initiate the punch on beat, so the VRAP system 108 must adjust the playback rate of the animation. The first animation portion, the windup, has a VRAP state that starts with the beginning of the animation, so the animation is immediately in a VRAP state. The VRAP system 108 looks for events on the drumbeat annotated track that would occur at the end of the windup, or up to one beat prior than the windup because that is the size of the search window. Suppose the player pressed the button in the exact middle of a beat (therefore, half a beat prior to the next event).

First, the VRAP system 108 determines the new animation playback rate for the VRAP state that covers the windup portion of the animation. The VRAP state starts half a beat prior to the next event. The song is 120 beats per minute, with a drumbeat event every beat. Thus, a beat is 0.5 seconds, and half a beat is 0.25 seconds. Thus, it is 0.25 seconds until the next event. The VRAP state is one beat, at an authored 180 beats per minute, so it is approximately 0.33 seconds long. The VRAP system 108 generates a search window of one beat prior to the end of the VRAP state, approximately 0.33 seconds in the future. One beat is 0.5 seconds, but the VRAP system 108 may not select an event in the past, so the search window ends up being between the current time and approximately 0.33 seconds in the future.

Within the search window, the VRAP system 108 finds an event at half a beat, 0.25 seconds, in the future. This is the event that causes the least distortion (since it is the only event), so it is selected to use to match the sync point. The VRAP system 108 determines that the VRAP system 108 needs to adjust animation playback rate so the approximately 0.33 seconds of the VRAP state is played in 0.25 seconds. The VRAP system 108 calculates that the animation playback rate should be approximately 0.33/0.25, which is approximately 1.33. The VRAP system 108 sets the animation playback rate of the animation to be 1.33× the rate at which it was authored. The animation continues, and the windup portion ends exactly on a beat. The VRAP system 108 sets the playback rate back to 1.0× the rate at which it was authored.

Next, the swing portion of the animation plays. The VRAP state for the swing starts as soon as the windup VRAP state ends, so it starts exactly on a beat. The swing (and VRAP state for the swing) is one beat long at an authored 180 beats per minute. Without the VRAP system, it would take approximately 0.33 seconds, which is the sync point for this VRAP state. Preferences for this VRAP state are to look for an event around the sync point with a search window size of one beat. One beat in this song is 0.5 seconds, so the search window starts 0.25 seconds prior to the sync point and ends 0.25 seconds after the sync point. Thus, the search window extends from (approximately 0.33 seconds−0.25 seconds), which is approximately 0.08 seconds in the future to (approximately 0.33 seconds+0.25 seconds), which is approximately 0.58 seconds in the future.

This VRAP state started exactly on the beat of the song, which is at 120 beats per minute, so there is an event at 0.5 seconds in the future. The search window includes this event 0.5 seconds in the future (and only that event). The event 0.5 seconds in the future is selected as the event to use. The VRAP system 108 determines that the VRAP system 108 needs to adjust playback rate so the approximately 0.33 seconds of the VRAP state is played in 0.5 seconds. The VRAP system 108 determines that the playback rate should be approximately 0.33/0.5, which is approximately 0.66. The VRAP system 108 sets the animation playback rate of the animation to be 0.66× the rate at which it was authored. The animation continues, and the swing portion ends exactly on a beat. The VRAP system 108 then sets the playback rate back to 1.0× the rate at which it was authored.

Next, the follow through portion of the animation plays. This portion does not have a VRAP state, so it plays without modifications, at 1.0× the rate at which it was authored. It finishes in two beats at the authored 180 beats per minute, so it finishes in another approximately 0.66 seconds.

After the entire animation plays, a few things have happened. The animation started as soon as the player pressed the button, so the game felt responsive to the player. The windup portion of the punch animation ended exactly on a drumbeat to the song that was playing. The swing portion of the punch animation ended exactly on a drumbeat to the song that was playing. If an NPC were nearby, the impact of the punch would have been at the same time as the drumbeat of the song. The follow through took another approximately 0.66 seconds, as authored, and did not line up with any of the music. The video game developer intended this because the video game developer did not create a VRAP state for the follow through portion of the animation. The entire animation took (0.25+0.5+approximately 0.66), which is approximately 1.41 seconds. The video game developer authored the animation to take four beats at the authored 180 beats per minute, so approximately 1.33 seconds. Anyone viewing the game would see a punch that looked as if the video game developer authored the punch to fit in that exact moment of the song. Accordingly, the VRAP system 108 may provide the player and anyone viewing with an enjoyable experience.

### Other Uses of Annotated Tracks

The video game 106, as well as other video games that do not include or utilize the VRAP system 108, may utilize annotated tracks for other purposes. Using annotated tracks allows video game developers to author effects at game development time and be confident they will trigger at runtime at the appropriate moment in the song. Complex data can be associated with events, so video game developers have a lot of flexibility in how to use them. Some examples of how the video game 106 may utilize the annotated tracks include: changing the color or intensity of lights in a video game level as the music plays; controlling the timing of NPC attacks; advancing the phase of the current video game level (for example, a video game level may be on a subway platform in one phase and in a subway car in the next phase); and defining key moments in the song when the player can initiate special moves or attacks. The following paragraphs describe such uses in more detail.

### Video Game Lights

Events can contain color information and light intensity information. This can be used to create annotated tracks that define various ways to light the level within the video game at runtime. Ambient lighting, but also point lights such as torches, spotlights, headlights, or any other light source can be driven by events in an annotated track. This could result in in-game light shows similar to those run during large concerts in real life.

### Color Swapping

As an intensity of music song changes, images in the video game level can change colors. Examples would be graffiti going from a drab color to a bright neon color, posters being “removed” from the level by being set to be transparent, or a “Wanted” poster changing from blending into the wall behind it to being highlighted in bright colors.

### Non-Player Character Attacks and Movement

Non-player characters (NPCs) may act in time with the music. Using annotated tracks to control things such as aggressiveness and attack timing of NPCs ensures that NPCs act in a way that matches the music. One example may be that an annotated track may have events that are moments in the song where an NPC might attack the player character. Another example may be that an annotated track may have events that include intensity data in the form of a number. This number would change a gameplay setting that controls how frequently the NPCs attack the player character.

### Level Phase Changes

Some video games may make changes to the video game level at runtime as the music advances. An example of a change like this would be a level that starts on a subway platform and switches to a subway car when the song changes verses. Annotated tracks can control these phase changes so that they occur at runtime at the proper part of the song.

### Dramatic Sync Opportunities

There may be key moments in the song that can be leveraged for dramatic moments for players as they are playing. One example may be just prior to a drumroll in a song, if player input initiates an attack, the player character would begin a flurry of punches in time to the drumroll. The annotated track for this kind of synchronization would include events for when the player needs to initiate an attack as well as for each hit of the drums during the drumroll. Another example may be that at a key moment in the song such as a crescendo, the player character could strike an iconic pose. The annotated track for this would be mostly empty, with just an event at the key moment.

The VRAP system 108 and the annotated tracks unlock gameplay in new ways. Music may drive the action of the video game 106 and engage players. Players may play the video game 106 and immerse themselves in the music without needing to adhere to strict input rules. Players may get creative control over how they play and interact with the video game 106. Regardless of how players decide to play, the result may be an audiovisual spectacle with beautiful, synchronized choreography.

In some aspects, the techniques described herein relate to a method including: while executing a video game played by a player: playing music, the music associated with multiple events; receiving an input from the player to cause an animation to be played, the animation including a portion having a variable rate animation playback state; commencing, without delay, playing the animation; while playing the animation, determine that the animation has entered the variable rate animation playback state; selecting an event from the multiple events associated with the music; determining, based on the event, an animation playback rate for the portion of the animation, the animation playback rate such that, when the portion of the animation is played at the animation playback rate, the portion of the animation ends when the music reaches the event; and playing the portion of the animation at the animation playback rate, wherein the portion of the animation ends when the music reaches the event.

In some aspects, the techniques described herein relate to a method, further including: accessing one or more tracks associated with the music, wherein each event of the multiple events is in a track of the one or more tracks; identifying a sync point in the portion of the animation; generating, based on the sync point, a search window for events in the one or more tracks; and identifying one or more events in the search window, wherein selecting the event includes selecting the event from the one or more events identified as in the search window.

In some aspects, the techniques described herein relate to a method wherein selecting the event further includes selecting the event that is either earliest in the search window or latest in the search window.

In some aspects, the techniques described herein relate to a method wherein selecting the event further includes selecting the event based on least distortion to the animation.

In some aspects, the techniques described herein relate to a method wherein the least distortion to the animation is determined by comparing absolute differences in times of a playing of the portion of the animation for the one or more events identified as in the search window.

In some aspects, the techniques described herein relate to a method wherein the least distortion to the animation is determined by an inverse relationship comparing time compression to time expansion.

In some aspects, the techniques described herein relate to a method wherein selecting the event further includes selecting the event based on a logarithmic function.

In some aspects, the techniques described herein relate to a method, further including: receiving the music; receiving a beat rate for the music; determining, based on the beat rate, multiple beats for the music; creating, based on the multiple beats, at least some of the multiple events; and associating the at least some of the multiple events with the music.

In some aspects, the techniques described herein relate to a method, further including receiving an offset for the music, wherein creating the at least some of the multiple events is further based on the offset.

In some aspects, the techniques described herein relate to a method wherein the event is a first event, and further including: determining that the music reaches a second event; and generating, based on the second event, an effect in the video game.

In some aspects, the techniques described herein relate to a method wherein generating the effect in the video game includes one or more of generating lighting in the video game, modifying one or more colors in the video game, controlling one or more non-player character actions in the video game, controlling one or more player character actions in the video game, and changing a level of the video game.

In some aspects, the techniques described herein relate to one or more non-transitory computer-readable media including executable instructions that when executed by one or more processors of a system cause the system to perform a method including: playing music, the music associated with multiple events; receiving an input to cause an animation to be played, the animation including a portion configured for variable rate animation playback and including a sync point; commencing playing the animation; selecting an event from the multiple events; determining, based on the event, an animation playback rate for the portion of the animation, the animation playback rate such that, when the portion of the animation is played at the animation playback rate, the portion of the animation arrives at the sync point when the music reaches the event; and playing the portion of the animation at the animation playback rate, wherein the portion of the animation arrives at the sync point when the music reaches the event.

In some aspects, the techniques described herein relate to one or more non-transitory computer-readable media, the method further including: accessing one or more tracks associated with the music, wherein each event of the multiple events is in a track of the one or more tracks; generating, based on the sync point, a search window for events in the one or more tracks; and identifying one or more events in the search window, wherein selecting the event includes selecting the event from the one or more events identified as in the search window.

In some aspects, the techniques described herein relate to one or more non-transitory computer-readable media wherein selecting the event further includes selecting the event that is either earliest in the search window or latest in the search window.

In some aspects, the techniques described herein relate to one or more non-transitory computer-readable media wherein selecting the event further includes selecting the event based on least distortion to the animation.

In some aspects, the techniques described herein relate to one or more non-transitory computer-readable media wherein the least distortion to the animation is determined by comparing absolute differences in times of a playing of the portion of the animation for the one or more events identified as in the search window.

In some aspects, the techniques described herein relate to one or more non-transitory computer-readable media wherein the least distortion to the animation is determined by an inverse relationship comparing time compression to time expansion.

In some aspects, the techniques described herein relate to one or more non-transitory computer-readable media wherein selecting the event further includes selecting the event based on a logarithmic function.

In some aspects, the techniques described herein relate to one or more non-transitory computer-readable media, the method further including: receiving the music; receiving a beat rate for the music; determining, based on the beat rate, multiple beats for the music; creating, based on the multiple beats, at least some of the multiple events; and associating the at least some of the multiple events with the music.

In some aspects, the techniques described herein relate to one or more non-transitory computer-readable media, the method further including receiving an offset for the music, wherein creating the at least some of the multiple events is further based on the offset.

In some aspects, the techniques described herein relate to one or more non-transitory computer-readable media wherein the method is performed while the system executes a video game played by a player, the music is included in the video game, the event is a first event, and the method further includes: determining that the music reaches a second event; and generating, based on the second event, an effect in the video game.

In some aspects, the techniques described herein relate to one or more non-transitory computer-readable media wherein generating the effect in the video game includes one or more of generating lighting in the video game, modifying one or more colors in the video game, controlling one or more non-player character actions in the video game, controlling one or more player character actions in the video game, and changing a level of the video game.

In some aspects, the techniques described herein relate to a system including at least one processor and at least one memory including executable instructions that when executed by the at least one processor cause the system to: play music, the music associated with multiple events; receive an input to cause an animation to be played, the animation including a portion configured for variable rate animation playback and including a sync point; commence playing the animation; select an event from the multiple events; determine, based on the event, an animation playback rate for the portion of the animation, the animation playback rate such that, when the portion of the animation is played at the animation playback rate, the portion of the animation arrives at the sync point when the music reaches the event; and play the portion of the animation at the animation playback rate, wherein the portion of the animation arrives at the sync point when the music reaches the event.

In some aspects, the techniques described herein relate to a method including: receiving music for interactive audiovisual content; receiving multiple events; associating the multiple events with the music; receiving an animation for the interactive audiovisual content; and configuring a portion of the animation for variable rate animation playback and to include a sync point, wherein, when the animation and the music are playing in the interactive audiovisual content, an event is selected from the multiple events and an animation playback rate is determined based on the event such that, when the portion of the animation is played at the animation playback rate, the portion of the animation arrives at the sync point when the music reaches the event.

In some aspects, the techniques described herein relate to a method wherein the music includes a song and one or more tracks of the song, and further including: setting a track granularity for a track of the one or more tracks; associating musical notes with the track; and adjusting, based on the track granularity, timing of the musical notes associated with the track.

In some aspects, the techniques described herein relate to a method, further including receiving one or more parameters that control how the animation playback rate is determined.

In some aspects, the techniques described herein relate to a method wherein the one or more parameters specify whether beats of the music or subdivisions of the beats are to be used as events of the multiple events.

In some aspects, the techniques described herein relate to a method wherein the one or more parameters specify how to generate, based on the sync point, a search window for events.

In some aspects, the techniques described herein relate to a method, wherein the one or more parameters further specify how to select the event from one or more events identified as in the search window.

In some aspects, the techniques described herein relate to a method wherein the one or more parameters further specify one of multiple methods to be used to select the event, the multiple methods including selecting the event that is earliest in the search window, selecting the event that is latest in the search window, selecting the event that results in a least distortion to the animation, or selecting the event based on a logarithmic function.

In some aspects, the techniques described herein relate to a method wherein the interactive audiovisual content includes a video game.

In some aspects, the techniques described herein relate to one or more non-transitory computer-readable media including executable instructions that when executed by one or more processors of a system cause the system to perform a method including: receiving music for an interactive audiovisual content; receiving multiple events; associating the multiple events with the music; receiving an animation for the interactive audiovisual content; and configuring a portion of the animation for variable rate animation playback and to include a sync point, wherein, when the animation and the music are playing in the interactive audiovisual content, an event is selected from the multiple events and an animation playback rate is determined based on the event such that, when the portion of the animation is played at the animation playback rate, the portion of the animation arrives at the sync point when the music reaches the event.

In some aspects, the techniques described herein relate to one or more non-transitory computer-readable media wherein the music includes a song and one or more tracks of the song, and the method further includes: setting a track granularity for a track of the one or more tracks; associating musical notes with the track; and adjusting, based on the track granularity, timing of the musical notes associated with the track.

In some aspects, the techniques described herein relate to one or more non-transitory computer-readable media, the method further including receiving one or more parameters that control how the animation playback rate is determined.

In some aspects, the techniques described herein relate to one or more non-transitory computer-readable media wherein the one or more parameters specify whether beats of the music or subdivisions of the beats are to be used as events of the multiple events.

In some aspects, the techniques described herein relate to one or more non-transitory computer-readable media wherein the one or more parameters specify how to generate, based on the sync point, a search window for events.

In some aspects, the techniques described herein relate to one or more non-transitory computer-readable media, wherein the one or more parameters further specify how to select the event from one or more events identified as in the search window.

In some aspects, the techniques described herein relate to one or more non-transitory computer-readable media wherein the one or more parameters further specify one of multiple methods to be used to select the event, the multiple methods including selecting the event that is earliest in the search window, selecting the event that is latest in the search window, selecting the event that results in a least distortion to the animation, or selecting the event based on a logarithmic function.

In some aspects, the techniques described herein relate to one or more non-transitory computer-readable media wherein the interactive audiovisual content includes a video game.

In some aspects, the techniques described herein relate to a system including at least one processor and at least one memory including executable instructions that when executed by the at least one processor cause the system to: receive music for an interactive audiovisual content; receive multiple events; associate the multiple events with the music; receive an animation for the interactive audiovisual content; and configure a portion of the animation for variable rate animation playback and to include a sync point, wherein, when the animation and the music are playing in the interactive audiovisual content, an event is selected from the multiple events and an animation playback rate is determined based on the event such that, when the portion of the animation is played at the animation playback rate, the portion of the animation arrives at the sync point when the music reaches the event.

FIG. 10 depicts a block diagram of an example computing device 1000 according to some embodiments. The computing device 1000 is shown in the form of a general-purpose computing device. The computing device 1000 includes at least one processor 1002, which may be or include one or more central processing units (CPUs) or one or more graphics processing units (GPUs), random access memory 1004 (RAM 1004), communication interface 1006, input/output device 1008, storage 1010, and a system bus 1012 that couples various system components including storage 1010 to the at least one processor 1002. A set (which may be a physical set or a logical set) of one or more of the computing device 1000 may be referred to as a computing system.

System bus 1012 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computing device 1000 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1002 is configured to execute executable instructions (for example, programs). In some embodiments, the at least one processor 1002 comprises circuitry or any processor capable of processing the executable instructions.

In some embodiments, RAM 1004 stores programs or data. In various embodiments, working data is stored within RAM 1004. The data within RAM 1004 may be cleared or ultimately transferred to storage 1010, such as prior to reset or powering down the computing device 1000.

In some embodiments, the computing device 1000 is coupled to a network via communication interface 1006. The computing device 1000 can communicate with one or more networks such as a local area network (LAN), a general wide area network (WAN), or a public network (for example, the Internet).

In some embodiments, input/output device 1008 is any device that inputs data (for example, mouse, keyboard, stylus, sensors, etc.) or outputs data (for example, speaker, display, virtual reality headset).

In some embodiments, storage 1010 can include computer system readable media in the form of non-volatile memory, such as read only memory (ROM), programmable read only memory (PROM), solid-state drives (SSD), flash memory, or cache memory. Storage 1010 may further include other removable/non-removable, volatile/non-volatile computer system storage media. By way of example only, storage 1010 can be provided for reading from and writing to a non-removable, non-volatile magnetic media. The storage 1010 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1012 by one or more data media interfaces. As will be further depicted and described below, storage 1010 may include at least one program product having a set (for example, at least one) of program modules that are configured to carry out the functions of embodiments of the technology. In some embodiments, RAM 1004 is found within storage 1010.

Programs/utilities, having a set (at least one) of program modules may be stored in storage 1010 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the computing device 1000. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings.

Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A method performed by one or more computing devices, a computing device including at least one processor and memory, the method comprising:
while executing a video game played by a player:
playing music, the music associated with multiple events;
receiving an input from the player to cause an animation to be played, the input provided by an input device, the animation including a portion having a variable rate animation playback state;
commencing, without delay, playing the animation, the animation displayed by a display device;
while playing the animation, determining that the animation has entered the variable rate animation playback state;
selecting an event from the multiple events associated with the music;
determining, based on the event, an animation playback rate for the portion of the animation, the animation playback rate such that, when the portion of the animation is played at the animation playback rate, the portion of the animation ends when the music reaches the event; and
playing the portion of the animation at the animation playback rate, wherein the portion of the animation ends when the music reaches the event.

2. The method of claim 1, further comprising:
accessing one or more tracks associated with the music, wherein each event of the multiple events is in a track of the one or more tracks;
identifying a sync point in the portion of the animation;
generating, based on the sync point, a search window for events in the one or more tracks; and
identifying one or more events in the search window,
wherein selecting the event includes selecting the event from the one or more events identified as in the search window.

3. The method of claim 2 wherein selecting the event further includes selecting the event that is either earliest in the search window or latest in the search window.

4. The method of claim 2 wherein selecting the event further includes selecting the event based on least distortion to the animation.

5. The method of claim 4 wherein the least distortion to the animation is determined by comparing absolute differences in times of a playing of the portion of the animation for the one or more events identified as in the search window.

6. The method of claim 4 wherein the least distortion to the animation is determined by an inverse relationship comparing time compression to time expansion.

7. The method of claim 2 wherein selecting the event further includes selecting the event based on a logarithmic function.

8. The method of claim 1, further comprising:
receiving the music;
receiving a beat rate for the music;
determining, based on the beat rate, multiple beats for the music;
creating, based on the multiple beats, at least some of the multiple events; and
associating the at least some of the multiple events with the music.

9. The method of claim 8, further comprising receiving an offset for the music, wherein creating the at least some of the multiple events is further based on the offset.

10. The method of claim 1 wherein the event is a first event, and further comprising:
determining that the music reaches a second event; and
generating, based on the second event, an effect in the video game.

11. The method of claim 10 wherein generating the effect in the video game includes one or more of generating lighting in the video game, modifying one or more colors in the video game, controlling one or more non-player character actions in the video game, controlling one or more player character actions in the video game, and changing a level of the video game.

12. One or more non-transitory computer-readable media comprising executable instructions that when executed by one or more processors of a system cause the system to perform a method, the method comprising:
playing music, the music associated with multiple events;
receiving an input to cause an animation to be played, the input provided by an input device, the animation including a portion configured for variable rate animation playback and including a sync point;
commencing playing the animation, the animation displayed by a display device;
selecting an event from the multiple events;
determining, based on the event, an animation playback rate for the portion of the animation, the animation playback rate such that, when the portion of the animation is played at the animation playback rate, the portion of the animation arrives at the sync point when the music reaches the event; and
playing the portion of the animation at the animation playback rate, wherein the portion of the animation arrives at the sync point when the music reaches the event.

13. The one or more non-transitory computer-readable media of claim 12, the method further comprising:
accessing one or more tracks associated with the music, wherein each event of the multiple events is in a track of the one or more tracks;
generating, based on the sync point, a search window for events in the one or more tracks; and
identifying one or more events in the search window,
wherein selecting the event includes selecting the event from the one or more events identified as in the search window.

14. The one or more non-transitory computer-readable media of claim 13 wherein selecting the event further includes selecting the event that is either earliest in the search window or latest in the search window.

15. The one or more non-transitory computer-readable media of claim 13 wherein selecting the event further includes selecting the event based on least distortion to the animation.

16. The one or more non-transitory computer-readable media of claim 15 wherein the least distortion to the animation is determined by comparing absolute differences in times of a playing of the portion of the animation for the one or more events identified as in the search window.

17. The one or more non-transitory computer-readable media of claim 15 wherein the least distortion to the animation is determined by an inverse relationship comparing time compression to time expansion.

18. The one or more non-transitory computer-readable media of claim 13 wherein selecting the event further includes selecting the event based on a logarithmic function.

19. The one or more non-transitory computer-readable media of claim 12, the method further comprising:
receiving the music;
receiving a beat rate for the music;
determining, based on the beat rate, multiple beats for the music;
creating, based on the multiple beats, at least some of the multiple events; and
associating the at least some of the multiple events with the music.

20. The one or more non-transitory computer-readable media of claim 19, the method further comprising receiving an offset for the music, wherein creating the at least some of the multiple events is further based on the offset.

21. The one or more non-transitory computer-readable media of claim 12 wherein the method is performed while the system executes a video game played by a player, the music is included in the video game, the event is a first event, and the method further comprises:
determining that the music reaches a second event; and
generating, based on the second event, an effect in the video game.

22. The one or more non-transitory computer-readable media of claim 21 wherein generating the effect in the video game includes one or more of generating lighting in the video game, modifying one or more colors in the video game, controlling one or more non-player character actions in the video game, controlling one or more player character actions in the video game, and changing a level of the video game.

23. A system comprising at least one processor and at least one memory including executable instructions that when executed by the at least one processor cause the system to:
play music, the music associated with multiple events;
receive an input to cause an animation to be played, the input provided by an input device, the animation including a portion configured for variable rate animation playback and including a sync point;
commence playing the animation, the animation displayed by a display device;
select an event from the multiple events;
determine, based on the event, an animation playback rate for the portion of the animation, the animation playback rate such that, when the portion of the animation is played at the animation playback rate, the portion of the animation arrives at the sync point when the music reaches the event; and
play the portion of the animation at the animation playback rate, wherein the portion of the animation arrives at the sync point when the music reaches the event.

24. A method performed by one or more computing devices, a computing device including at least one processor and memory, the method comprising:
receiving music for interactive audiovisual content;
receiving multiple events;
associating the multiple events with the music;
receiving an animation for the interactive audiovisual content; and
configuring a portion of the animation for variable rate animation playback and to include a sync point,
wherein, when the animation and the music are playing in the interactive audiovisual content, the animation displayed by a display device, an event is selected from the multiple events and an animation playback rate is determined based on the event such that, when the portion of the animation is played at the animation playback rate, the portion of the animation arrives at the sync point when the music reaches the event.

25. The method of claim 24 wherein the music includes a song and one or more tracks of the song, and further comprising:
setting a track granularity for a track of the one or more tracks;
associating musical notes with the track; and
adjusting, based on the track granularity, timing of the musical notes associated with the track.

26. The method of claim 24, further comprising receiving one or more parameters that control how the animation playback rate is determined.

27. The method of claim 26 wherein the one or more parameters specify whether beats of the music or subdivisions of the beats are to be used as events of the multiple events.

28. The method of claim 26 wherein the one or more parameters specify how to generate, based on the sync point, a search window for events.

29. The method of claim 28, wherein the one or more parameters further specify how to select the event from one or more events identified as in the search window.

30. The method of claim 29 wherein the one or more parameters further specify one of multiple methods to be used to select the event, the multiple methods including selecting the event that is earliest in the search window, selecting the event that is latest in the search window, selecting the event that results in a least distortion to the animation, or selecting the event based on a logarithmic function.

31-40. (canceled)
